(19) United States
(12) Patent Application Publication
(10) Pub. No.: US 2010/0053221 A1
(43) Pub. Date: Mar. 4, 2010

(54) INFORMATION PROCESSING APPARATUS AND OPERATION METHOD THEREOF

(75) Inventors: Kazue Kaneko, Kawasaki-shi (JP); Hiroki Yamamoto, Yokohama-shi (JP); Katsutoshi Nagato, Tachikawa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/536,988

(22) Filed: Aug. 6, 2009

(30) Foreign Application Priority Data
Sep. 3, 2008 (JP) 2008-226376
Jul. 27, 2009 (JP) 2009-174517

(51) Int. Cl. G09G 5/00; G06F 3/048; G06F 3/041

(52) U.S. Cl. 345/684; 715/786; 345/173

(57) ABSTRACT

An information processing apparatus that can fix the position at which some of a plurality of objects are displayed, and scroll objects other than these objects in that state, using a small number of procedural steps is provided. A recognition unit recognizes that a plurality of positions have been designated on a display on which objects are displayed. Where a first position corresponding to a position at which one of a plurality of objects is displayed is recognized by the recognition unit, and a second position corresponding to a position that is located on the display and at which a designated object is not displayed is recognized by the recognition unit, a display control unit scrolls objects other than the designated object, when a movement of the second position has been detected.

### BACKGROUND OF THE INVENTION

1. Field of the Invention

The present invention relates to a technique for placing an object image such as a graphic, an image, or a character, and viewing and editing that object image.

2. Description of the Related Art

Conventionally, a display system called “scroll view” is employed when a screen that can be displayed is small relative to the size of the content that is to be viewed/edited with software having a graphical user interface (GUI).

In this system, a portion of the screen is displayed after being clipped to the size of a screen that can be displayed, and a scroll bar for up-and-down or left-and-right movements is provided to move (scroll) the displayed screen by clicking or dragging to a predetermined position.

Additionally, there is also another type of scroll view that has a mode in which scrolling is performed by a dragging operation on a screen to enable a more direct operation than an operation with a scroll bar.

However, a conventional pointing device such as a mouse can only have a single pointing point. Therefore, in order to perform scrolling, it is necessary to set a fixed region, namely, a scroll bar, or separately provide a mode in which a dragging operation on the screen corresponds to scrolling.

Techniques for providing a scroll instruction by sliding a plurality of fingers on a touch panel have been proposed (see e.g., Japanese Patent Laid-Open No. H11-102274).

In addition, techniques for performing scrolling using two fingers by fixing one finger and moving the other finger have been proposed (see e.g., Japanese Patent Laid-Open No. 2007-279638).

Further, techniques for performing scrolling by fixing one point and clicking another point have been proposed (see e.g., Japanese Patent Laid-Open No. 2002-091649).

As described above, techniques for simplifying a scroll operation by simultaneous designation of a plurality of points (multi-touch) on a touch panel have been proposed.

On the other hand, in the case of an application that executes an operation for placing objects on a screen and selecting any necessary object therefrom, one may wish to keep the display position of the selected object fixed while scrolling the other objects, thereby performing a viewing operation while comparing them.

One may also wish to add a new object to the selected object while repeatedly performing scrolling.

Some applications have a function for fixing the position of a specific object while scrolling the background. In this case, however, a scroll operation is executed after fixing the position of the object by changing its attributes.

Also, techniques for performing a drag and drop of an object by changing the distance between two points have been proposed (see e.g., Japanese Patent No. 3867226).

Further, techniques for enlarging, reducing, and rotating an object by fixing one point and moving other points have been proposed (see e.g., Japanese Patent Laid-Open No. 2001-290585).

As described above, techniques for selecting and manipulating an object by using multi-touch have been proposed.

However, in the case of conventional applications having a function for locking an object and scrolling the background, there is only one point that can be designated using a mouse or the like, and therefore, it takes time and effort to fix the position of an object and to perform a scroll operation.

In the case where one wishes to add a new object to the selected objects while repeatedly performing scrolling, it is necessary to operate the mouse many times in order to drag the new object to the area where the object that has been already selected is located and to change its attributes to “locked”.

Although techniques for performing an operation for performing selection, movement, enlargement, reduction, rotation, or the like for an object with the use of multi-touch have been proposed, the background is not scrolled according to these techniques.

### SUMMARY OF THE INVENTION

According to the present invention, there is provided a technique that makes it possible, with a small number of procedural steps, to scroll objects other than a fixed object, while maintaining the display position of the fixed object, for example, by fixing an object at a single point, while providing a scroll instruction by dragging another point.

According to the present invention, there is also provided a technique that makes it possible to switch between moving, enlarging, reducing, or rotating an object or the background image, and scrolling the object and the background image, according to the number, the position, and the presence or absence of a movement, and the like of points that are designated.

Furthermore, it is an objective of the present invention to switch to scrolling, while keeping an object fixed, objects other than that fixed object and the background image.

One aspect of the present invention provides an information processing apparatus that controls a display position of an object displayed in a display unit comprising a display unit configured to display an object, a recognition unit configured to recognize that a plurality of positions on the display unit have been designated, and a display control unit configured, where a first position corresponding to a position at which one of a plurality of objects is displayed is recognized by the recognition unit and a second position corresponding to a position that is located on the display unit and at which a designated object is not displayed is recognized by the recognition unit, to scroll objects other than the designated object, when a movement of the second position has been detected.

According to the present invention, it is possible, with a small number of procedural steps, to scroll objects other than a fixed object, while maintaining the display position of the fixed object, for example, by fixing an object at a single point, while providing a scroll instruction by dragging another point.

Furthermore, according to the present invention, it is possible, with a small number of procedural steps, to add an object that is to be fixed, by selecting and dragging, while fixing an object at one position, the object that is to be newly added at another point.

Furthermore, according to the present invention, it is possible to repeatedly perform scrolling and addition of an object by operating another point while continuously designating an object that is to be fixed, thereby enabling efficient operations for comparing and collecting objects.

Furthermore, according to the present invention, it is possible to switch whether to move, enlarge, reduce, or rotate an object or the background image, or to scroll the object and the background image, according to the number, the position, and the presence or absence of a movement, and the like of points that are designated.

Furthermore, according to the present invention, it is possible to switch whether to scroll, while keeping an object fixed, objects other than that fixed object and the background image.

Further features of the present invention will become apparent from the following description of exemplary embodiments with reference to the attached drawings.

### BRIEF DESCRIPTION OF THE DRAWINGS

FIGS. 1A and 1B are diagrams illustrating the configuration of an information processing apparatus.

FIG. 2 is a flowchart illustrating display control processing.

FIG. 3 is a flowchart illustrating designation start processing.

FIG. 4 is a flowchart illustrating movement processing.

FIG. 5 is a flowchart illustrating undesignation processing.

FIG. 6 is a flowchart illustrating a modification of designation start processing.

FIG. 7 is a flowchart illustrating a modification of movement processing.

FIG. 8 is a flowchart illustrating a modification of undesignation processing.

FIGS. 9A to 9C are diagrams showing the sizes and positions of regions displayed on a display screen.

FIGS. 10A to 10D are diagrams showing the details of a content management table.

FIGS. 11A to 11C are diagrams showing the details of a content management table.

FIGS. 12A and 12C are diagrams showing the relationship between the entire content and a display screen.

FIGS. 13A and 13D are diagrams showing the relationship between the entire content and a display screen.

FIGS. 14A to 14D are diagrams showing the relationship between the entire content and a display screen.

FIGS. 15A to 15H are diagrams illustrating operations performed on a display screen.

FIGS. 16A to 16H are diagrams illustrating operations performed on a display screen.

FIGS. 17A to 17C are diagrams illustrating operations performed on a display screen.

FIG. 18 is a flowchart illustrating processing for switching operations for objects and a background image.

FIGS. 19A to 19D are flowcharts illustrating processing for switching operations for objects and a background image.

FIGS. 20A to 20M are diagrams showing an example of an operation performed on an object and a background image.

### DESCRIPTION OF THE EMBODIMENTS

Hereinafter, preferred embodiments of the present invention are described in detail with reference to the accompanying drawings. It should be noted that the following embodiments are not to be construed as limiting the invention, but as illustrating specific examples that are advantageous for the implementation of the present invention.

In addition, all of the combinations of features that are described in the following embodiments are not necessarily essential to the problem solving means of the present invention.

### Embodiment 1

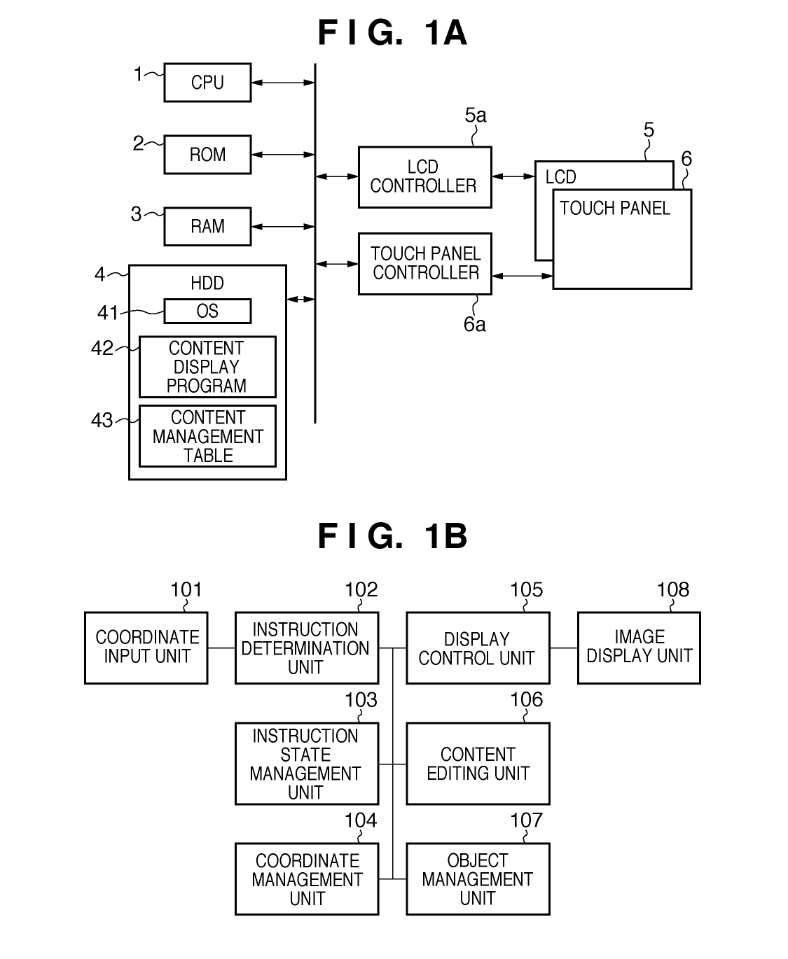

FIG. 1A is a diagram illustrating the hardware configuration of an information processing apparatus according to this embodiment.

This information processing apparatus has the following configuration, including a CPU 1 that controls the overall apparatus, a ROM 2 in which a boot program, fixed data, and the like are stored, and a RAM 3 that functions as a main storage.

An HDD 4 is a hard disk device, in which an operating system (OS) 41, a content display program 42, and a content management table 43 are stored.

An LCD 5 is a liquid crystal display, which is an exemplary display unit, to which image data is supplied by an LCD controller 5a. A touch panel 6, which constitutes a coordinate input unit, is superimposed on the surface of the LCD 5.

As a system for the touch panel, any known system such as an ultrasonic system, a photoelectric system, or a capacitance system may be employed. A touch panel controller 6a detects the coordinates of a position at which the user has come into contact with the touch panel 6, and issues an interrupt signal thereof to the CPU 1.

Here, the touch panel controller 6a is configured to accept touching and dragging operations in at least two locations.

FIG. 1B is a block diagram illustrating the functional configuration of the information processing apparatus according to this embodiment.

The information processing apparatus includes a coordinate input unit 101, an instruction determination unit 102, an instruction state management unit 103, a coordinate management unit 104, a display control unit 105, a content editing unit 106, an object management unit 107, and an image display unit 108.

The coordinate input unit 101 detects designation (touching), movement (dragging), and undesignation of a point located on the LCD 5. The instruction determination unit 102 determines which coordinate input corresponds to which instruction. The instruction state management unit 103 manages the instruction state determined by a plurality of coordinate inputs.

The coordinate management unit 104 manages the coordinates of an image that can be displayed (display screen) on the coordinates (content coordinates) of an object placement screen on which a plurality of objects are placed.

The display control unit 105 extracts a displayable portion of the content on which objects are placed, and causes the LCD 5 to display that portion. The content editing unit 106 places the objects and changes the coordinates.

The object management unit 107 manages the state of objects. The image display unit 108 displays at least a portion of the object placement screen, and is realized by the LCD 5.

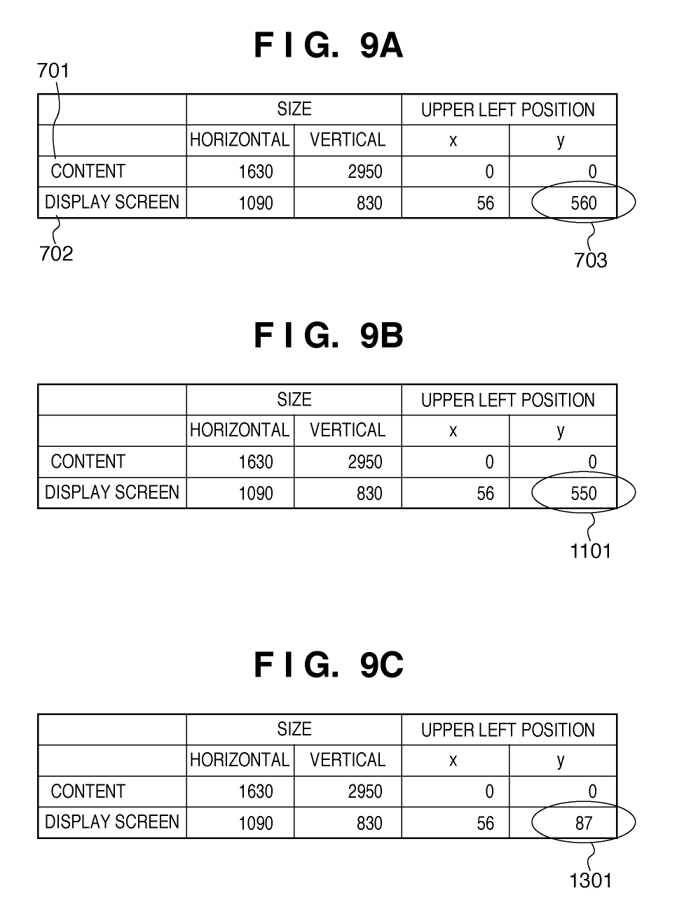

The following describes a scroll operation that can be performed with the information processing apparatus of this embodiment, while maintaining the display position of a fixed object, with reference to FIGS. 9A to 9C, 10A to 10D, 12A to 12C, 15A, and 15B.

The content display program 42 in this embodiment may be, for example, a browser program for content such as a photograph file.

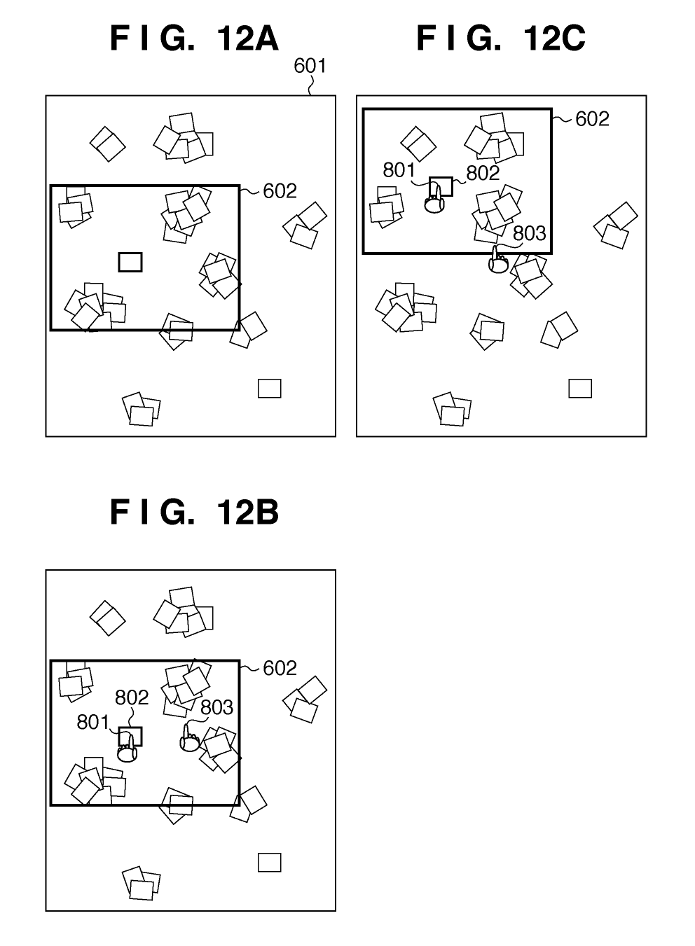

Upon starting the content display program 42, at least a portion of an object placement screen on which at least one object is placed as shown in FIG. 12A is displayed on the LCD 5. An object represents, for example, a representative image for each piece of content.

FIG. 12A is a diagram showing a display example of content that is to be manipulated, a displayable image (display screen), and objects.

601 in FIG. 12A denotes the entire object placement screen (content). It is the portion in the thick-bordered display screen denoted by 602 that is actually displayed on the LCD 5 and is operated by the user.

FIG. 9A shows the correspondence between the coordinates of the content and the display screen shown in FIG. 12A. 701 denotes the coordinates of the content, and 702 denotes the coordinates of the display screen. The upper left of the content is taken as the origin (0, 0), and the coordinates take positive values in the downward direction and the rightward direction. The coordinates of the upper right position of the display screen on the content coordinates are taken as the origin of the display screen.

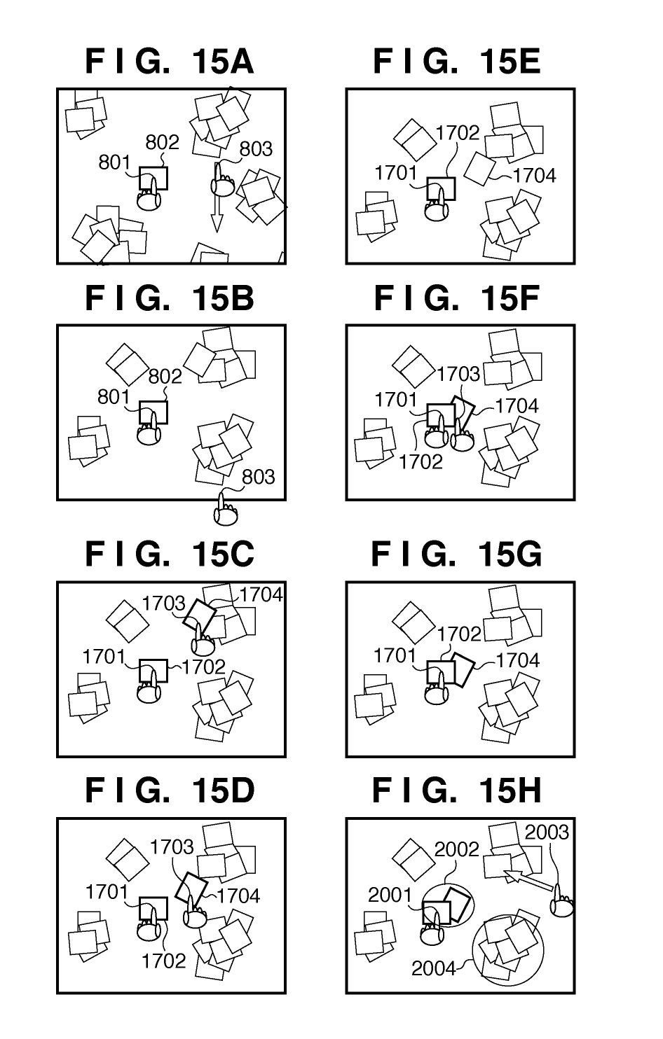

FIGS. 15A and 15B show a scroll operation that is performed while maintaining the display position of a locked (fixed) object.

A user can put a desired object (first object) into the selected state, for example, by touching that object with a left-hand finger during the display of a portion of the object placement screen.

By again touching the object that has been touched once and thus been put into the selected state, and continuously depressing the object at that position, the user can fix the position of the object. This is referred to as the “locked state”.

FIG. 15A shows the user putting a selected object 802 into the locked state by depressing the object 802 with the left hand 801, then depressing the background, where no object is present, and dragging the background in the downward direction, with the right hand 803.

FIG. 15B shows the state after dragging, in which 801 remains unmoved, and 803 in FIG. 15A has moved to the position of 803 in FIG. 15B.

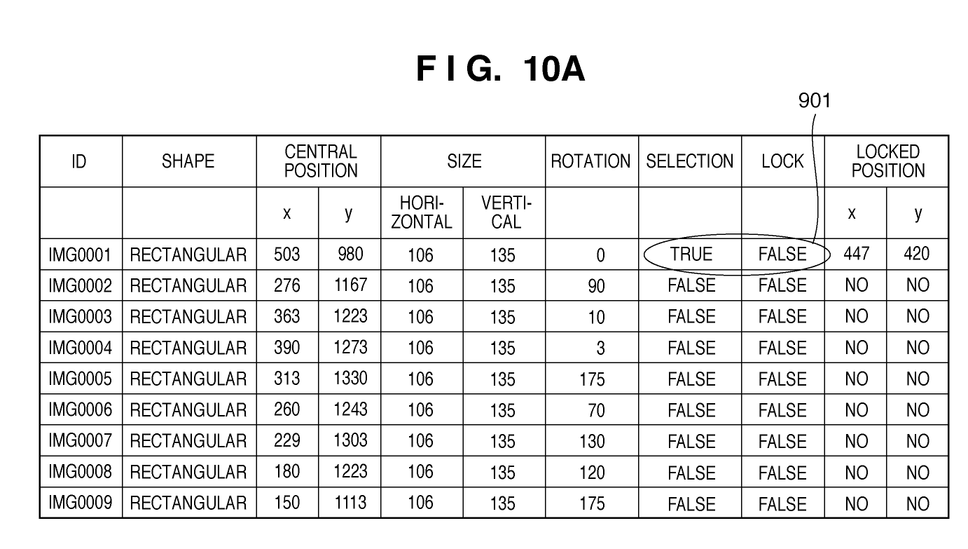

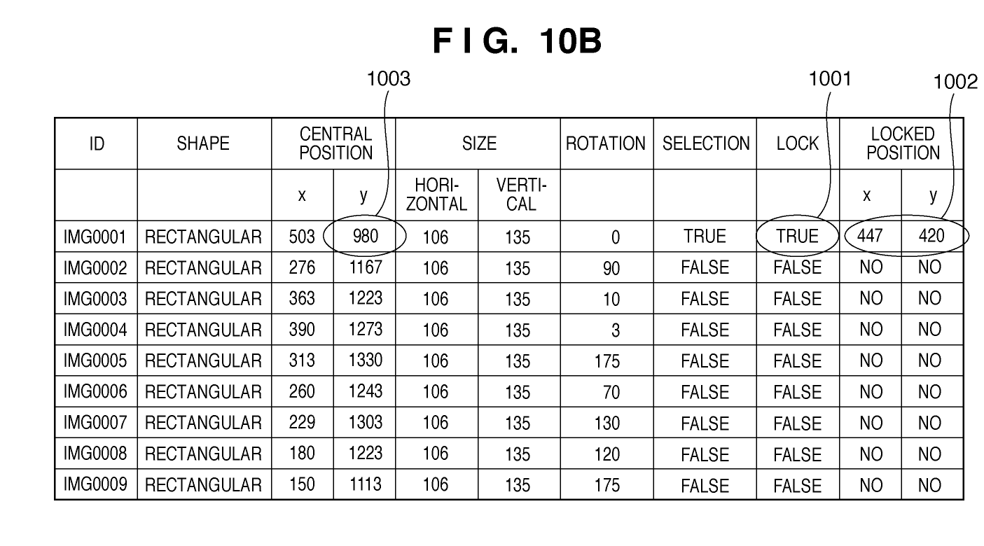

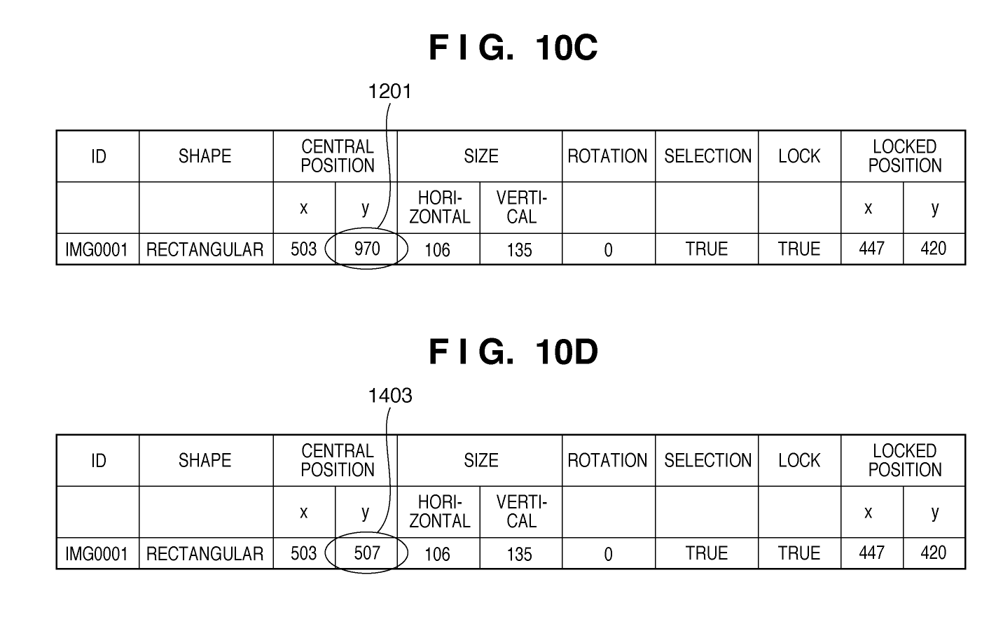

FIGS. 10A and 10B are diagrams showing the details of the content management table 43 during the scroll operation shown in FIGS. 15A and 15B.

In this table, as shown in the diagrams, data on shape, central position (the coordinates of the content), size, rotation, selection, lock, and lock position is held for each object ID. The display control unit 105 places each object with reference to the content management table 43.

FIG. 10A shows the state of the objects before locking, and FIG. 10B shows the state of the objects after locking. The object 802 in FIG. 15A is the object IMG0001.

While the selected state of IMG0001 is “TRUE” and the locked state thereof is “FALSE” in FIG. 10A as indicated by 901, the locked state of IMG0001 is “TRUE” in FIG. 10B as indicated by 1001.

In addition, the coordinates on the display screen at this time are recorded as the locked position as indicated by 1002. During the dragging performed from FIG. 15A to FIG. 15B, movement processing is repeatedly performed on the display screen and the locked object, and the display is updated.

FIG. 9B shows the coordinates of the content and the display screen immediately after movement processing by which the display screen has moved upward by 10. Since the upper left of the content is taken as the origin, the y-coordinate of the upper left position indicated by 1101 in FIG. 9B is smaller than the y-coordinate indicated by 703 in FIG. 9A by 10.

FIG. 10C shows the state of IMG0001 immediately after movement processing by which the display screen has moved upward by 10. The y-coordinate of the central position indicated by 1201 in FIG. 10C is smaller than 1003 in FIG. 10B by 10. FIG. 15B shows the state when the dragging has been stopped.

From this state, the scroll operation ends, with the right hand 803 being released. FIG. 9C shows the coordinates of the content and the display screen after strolling and FIG. 10D shows the state of IMG0001 after scrolling.

The y-coordinate of the upper left position indicated by 1301 in FIG. 9C is smaller than the y-coordinate indicated by 703 in FIG. 9A by 473. The y-coordinate of the central position indicated by 1403 in FIG. 10D is smaller than the y-coordinate indicated by 1003 in FIG. 10B by 473.

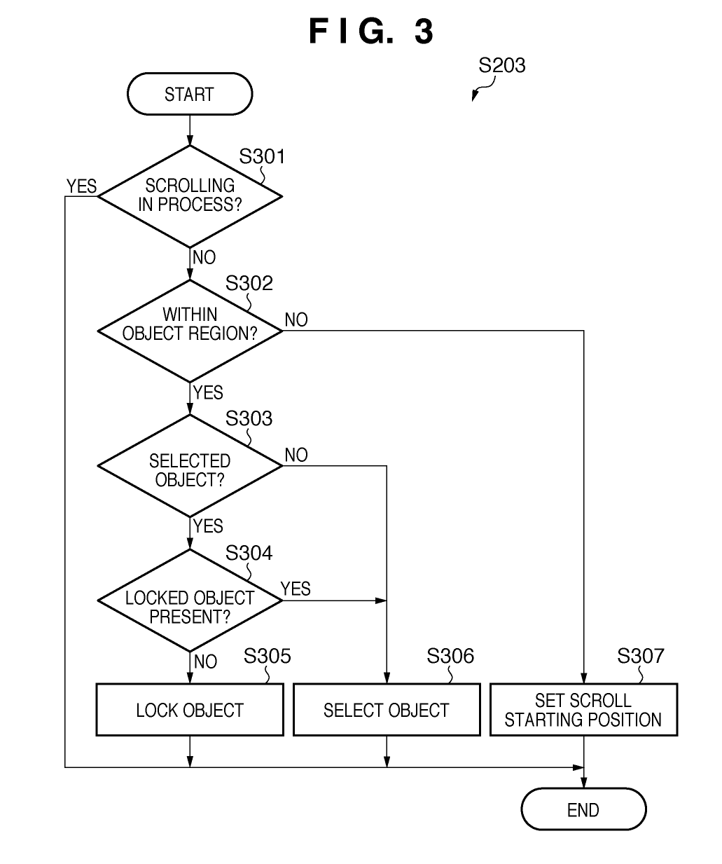

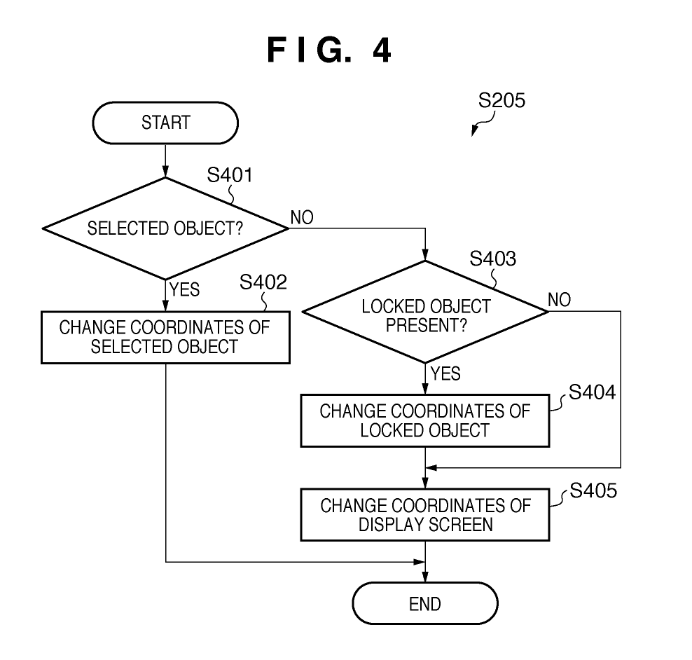

The lock operation is performed in step S305 in the below-described flowchart in FIG. 3, the movement operation is performed in step S404 and step S405 of the flowchart in FIG. 4, and the scroll cancellation is performed in step S508 of the flowchart in FIG. 5.

To the user performing the operation, only the display screen area can be viewed, and it looks as if the background is moving. However, when the content is viewed in its entirety, it is the display screen indicated by 602 and the locked object indicated by 802 that have moved, as shown in FIGS. 12B to FIG. 12C.

Note that the content of FIG. 15A as viewed in its entirety corresponds to FIG. 12B, and the content of FIG. 15B as viewed in its entirety corresponds to FIG. 12C.

In the following, an operation for selecting another object while maintaining the display position of a locked object is described with reference to FIGS. 15C to 15G.

In FIG. 15C, while depressing a locked object (first object) 1702 with the left hand 1701, the user selects another object (second object) 1704 by depressing it with the right hand 1703.

Then, as shown in FIG. 15D, the user moves the second object 1704 by dragging the right hand 1703 to the lower left. The select operation is performed in step S306 of the flowchart in FIG. 3 described below, and the drag processing is executed in step S402 of the flowchart in FIG. 4.

When the user releases the right hand at the end point of such dragging as shown in FIG. 15E, the right hand 1703, which was present in FIGS. 15C and 15D, is no longer present, and the selected state of the second object 1704 is cancelled. This processing corresponds to step S507 of the flowchart in FIG. 5.

On the other hand, when the user drags the second object 1704 to a position overlapping the first object 1701 as shown in FIG. 15F, and releases the right hand 1703 as shown in FIG. 15G, the second object 1704 is added to the locked object.

That is, the second object 1704 is fixed, along with the first object 1701. This processing is executed in step S506 of the flowchart in FIG. 5.

Note that when the user drags the finger 1701 depressing the locked object, the object 1702 is moved in response to that dragging in step S402 of the flowchart in FIG. 4.

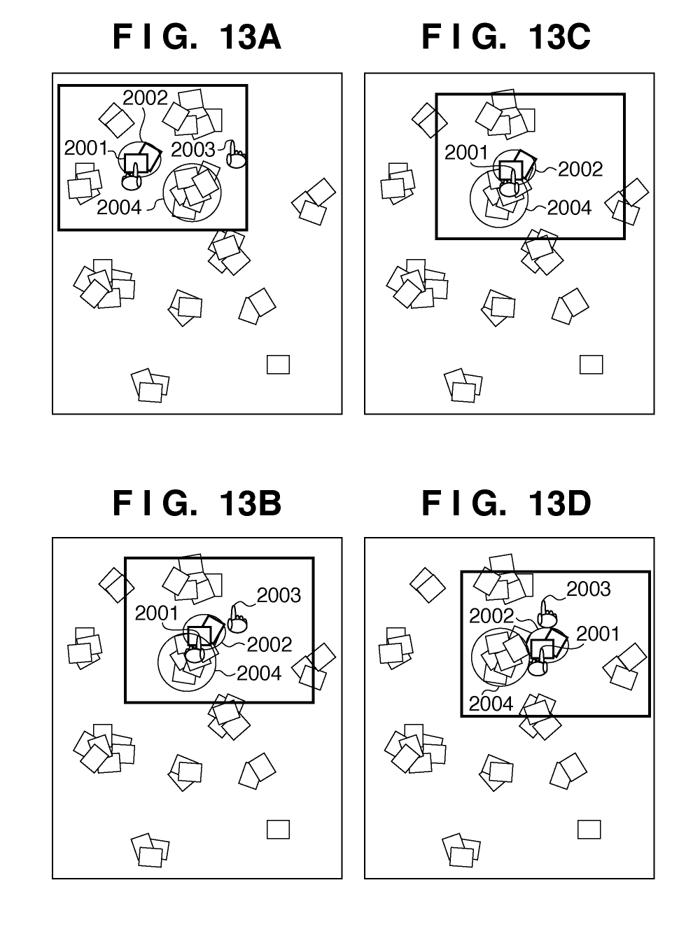

In the following, an operation performed in the case where a locked object has overlapped another object during scrolling is described with reference to FIGS. 13A to 13D, FIG. 15H, and FIGS. 16A to 16D.

In FIG. 15H, while keeping two objects 2002 locked by depressing them with the left hand 2001, the user drags a region in which no object is present to the upper left with the right hand 2003.

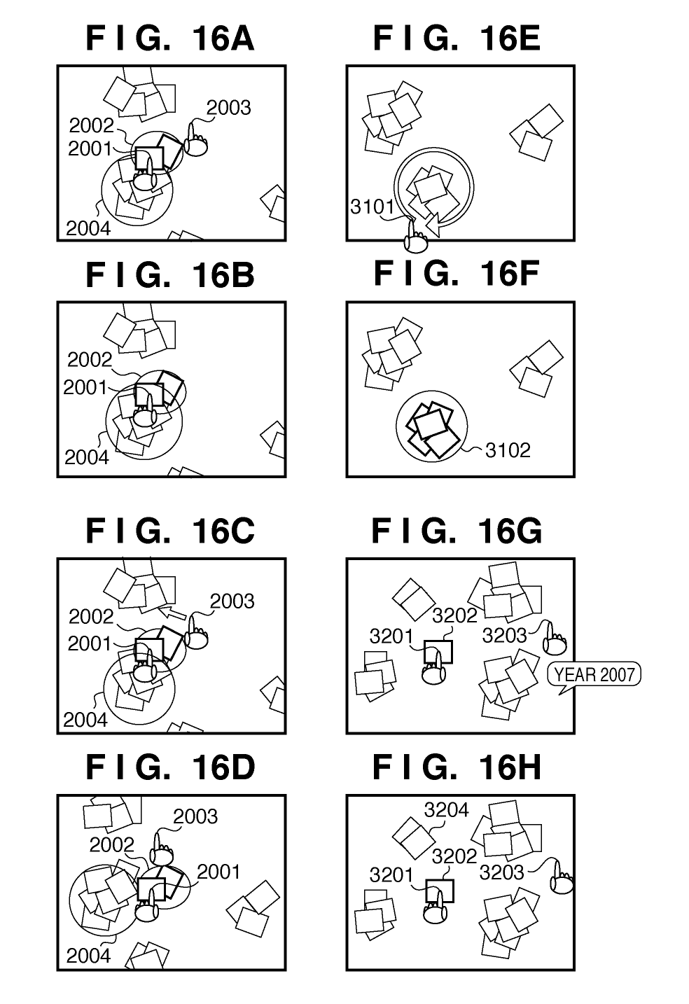

In FIG. 16A, when the dragging has been stopped, the locked objects 2002 and an object group 2004 that is being scrolled overlap. FIG. 16B shows a state in which the user has released the right hand 2003, thereby ending scrolling. At this time, the state of the object group 2004 located under the locked objects 2002 remains unchanged.

Since a point under a scroll instruction other than the selected objects has been undesignated, the scrolling is cancelled by the processing of step S508 in FIG. 5, but the locked state of the objects remains unchanged.

FIGS. 16C and 16D show a state when the user performs scrolling again while depressing the locked objects 2002. In FIG. 16C, the user drags a region in which no object is present to the upper left with the right hand 2003, while depressing the locked objects with the left hand 2001.

Then, as shown in FIG. 16D, the object group 2004 located under the locked objects is scrolled as it is.

To the user, only the display screen range can be viewed, and it looks as if the background is moving during the above-described operation. However, when the content is viewed in its entirety, it is the display screen and the locked objects that have moved, as shown in FIGS. 13A to 13D.

Note that FIG. 15H corresponds to FIG. 13A, FIG. 16A corresponds to FIG. 13B, FIG. 16B corresponds to FIG. 13C, FIG. 16C corresponds to FIG. 13B as in the case of FIG. 16A, and FIG. 16D corresponds to FIG. 13D.

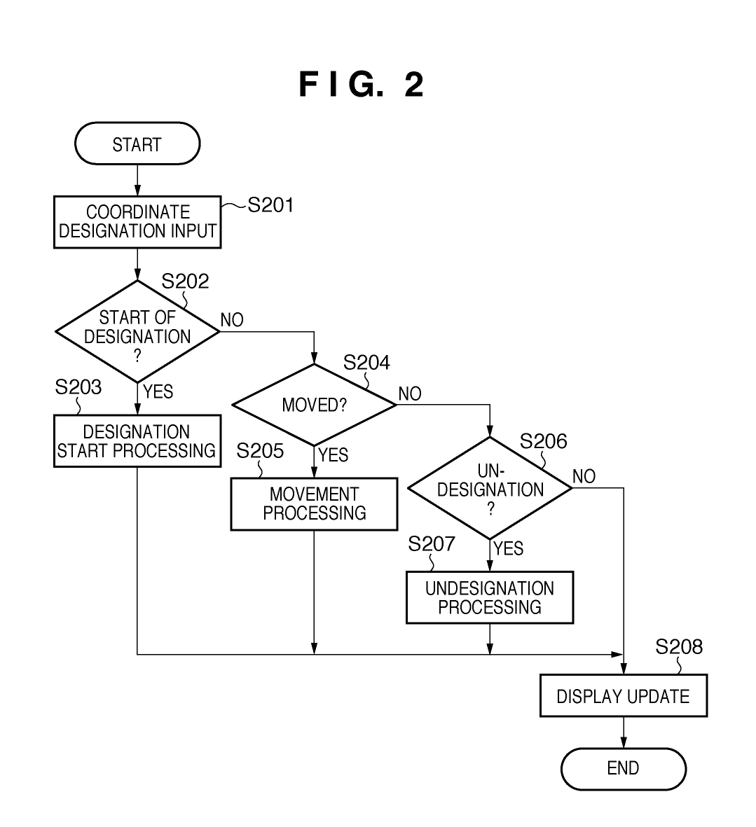

FIG. 2 is a flowchart illustrating display control processing that realizes the above-described operation. This processing is for accepting an input from the coordinate input unit 101, and executing processing according to the input, thereby updating the display, and is repeatedly started and terminated unless a stop instruction is issued.

Note that a program corresponding to this flowchart is included in the content display program 42, and is executed by the CPU 1 after being loaded onto the RAM 3.

First, in step S201, the coordinate input unit 101 accepts a depression instruction input by the user. Then, in step S202, the instruction determination unit 102 determines whether the input is the start of designation. For example, depressing an arbitrary point on the touch panel 6 corresponds to this input.

If it is determined in step S202 that the input is the start of designation, the instruction state management unit 103 or the like executes, in step S203, the designation start processing described below. Then, it executes the processing of step S208.

On the other hand, if it is determined in step S202 that the input is not the start of designation, the instruction determination unit 102 determines, in step S204, whether there has been a movement of the depressed position. Note that “movement” means that a designated point is already present, and a movement of that point has been detected.

That is, dragging on the touch panel 6 corresponds to this “movement”, for example. If it is determined in step S204 that there has been a movement, the instruction state management unit 103 or the like executes, in step S205, the movement processing described below. Then, it executes the processing of step S208.

On the other hand, if it is determined that there has been no movement, the instruction determination unit 102 or the like determines, in step S206, whether the input is undesignation. More specifically, the cancellation of the depression of a point on the touch panel 6 corresponds to this undesignation.

If it is determined in step S206 that the input is undesignation, the instruction state management unit 103 or the like executes, in step S207, the undesignation processing described later. Then, it executes the processing of step S208.

On the other hand, if it is not determined in step S206 that the input is undesignation, the instruction state management unit 103 or the like directly proceeds to execute the processing of step S208. In step S208, the display control unit 105 performs creation and redisplay (display update) of an image for the necessary area, and then the processing series ends.

Note that this processing allows simultaneous acceptance of designation for a plurality of points. Furthermore, by processing the start of designation, movement, and undesignation as separate events, it is possible to process the depression of a certain point and the depression of another point before the depression operation of the former point is cancelled.

In the case where a plurality of inputs are simultaneously made, the inputs are placed in a queue, and processed in order.

FIG. 3 is a flowchart illustrating the designation start processing in step S203.

In this embodiment, an action of depressing and dragging a point at which no object is present in the state where not a single point is designated is treated as a scroll instruction.

In FIG. 12A, the entire content area 601 in which rectangular objects are scattered is indicated by a thin frame, and a displayable portion (hereinafter, referred to as “display portion”) 602 therein is indicated by a thick frame.

That is, depressing and dragging a position that is not in contact with the objects in the display portion 602 results in scrolling.

First, in step S301, the instruction state management unit 103 or the like determines whether scrolling is in process. The instruction state is determined based on the type of previous coordinate inputs, and is recorded in the instruction state management unit 103.

Therefore, it is determined that scrolling is in process if depression of a point at which no object is present continues. On the other hand, if scrolling is in process, the processing series ends directly. The reason is to prevent another object from being selected, for example, by being touched by mistake during scrolling.

If scrolling is not in process, the coordinate management unit 104 or the like determines, in step S302, whether the designated point is within an object region.

If it is within an object region, the object management unit 107 or the like determines, in step S303, whether that object is an object that has been already selected.

If it is determined in step S303 that it is a selected object, the instruction state management unit 103 or the like determines, in step S304, whether there is any other object that has been put into a state in which its position on the display screen is to be fixed (locked state).

If it is determined in step S304 that there is no locked object, the instruction state management unit 103 or the like locks that object in step S305, and the processing series ends. Note that this locking of the object continues until the point is undesignated.

If it is determined in step S304 that another locked object is present, the instruction state management unit 103 or the like executes the processing of step S306. Similarly, if it is determined in step S303 that the designated object is not a selected object, the instruction state management unit 103 or the like executes the processing of step S306.

In step S306, the instruction state management unit 103 or the like puts the object into the selected state, and the processing series ends. Note that this selected state also continues until the point is undesignated.

If the designated point is outside an object region in step S302, the coordinate management unit 104 or the like sets a scroll starting point in step S307, thereby establishing a state in which scrolling is in process, and the processing series ends.

Note that this scrolled state also continues until the point is undesignated.

FIG. 4 is a flowchart illustrating the movement processing in step S205.

In step S401, the coordinate management unit 104 or the like determines whether the point that has moved is within the region of a selected object.

If it is within the region of a selected object, the coordinate management unit 104 or the like adds the amount of movement of the movement locus to the selected object in step S402, thereby changing the coordinates, and the processing series ends. Note that this corresponds to a drag operation of the selected object.

If it is determined in step S401 that the moved point is outside the region of a selected object, the instruction state management unit 103 or the like determines, in step S403, whether there is any locked object.

If a locked object is present, the coordinate management unit 104 or the like changes, in step S404, the coordinates of that object on the content coordinates so that the position of the object on the display screen will not change. Then, it executes the processing of step S405.

On the other hand, if there is no locked object in step S403, the coordinate management unit 104 or the like directly proceeds to execute the processing of step S405.

In step S405, the display control unit 105 or the like changes the coordinates of the display screen, and performs scrolling. Note that this movement processing is repeatedly performed from the start of movement until the end thereof. This processing is for changing the coordinates where necessary during movement, thereby preventing a delay in display.

FIG. 5 is a flowchart illustrating the undesignation processing in step S207.

In step S501, the instruction state management unit 103 or the like determines whether there is any selected object at the position that is to be undesignated. If a selected object is present, the object management unit 107 or the like determines, in step S502, whether the selected object is a locked object.

If the selected object is a locked object in step S502, the object management unit 107 or the like cancels the locked state of the object in step S503, and the processing ends.

This corresponds to releasing a finger that has been depressing an object that is locked. If scrolling is in process at this time, the locked state is cancelled and the object thus scrolls in that state.

If it is determined in step S502 that the selected object is not a locked object, the object management unit 107 or the like determines, in step S504, whether there is any other locked object.

If another locked object is present, the object management unit 107 or the like determines, in step S505, whether the selected object overlaps that locked object.

If they overlap, the object management unit 107 or the like adds the selected object that is undesignated to the locked object in step S506.

This corresponds to depressing a locked object with one hand, dragging a selected object with the other hand, thereby adding it to the locked object, and releasing that hand. The example shown in FIGS. 15F and 15G corresponds to this.

On the other hand, if it is determined in step S504 that there is no locked object, the processing series ends without performing any action. That is, if there is no locked object, no action is performed even when the depression of the selected object is cancelled.

A method for cancelling the selection of a selected object when there is no locked object will be described later.

If it is determined in step S505 that there is no overlapping region between the selected object and a locked object, the instruction state management unit 103 or the like cancels the selected state of that object in step S507, and the processing ends.

This corresponds to selecting another object while maintaining the locked object, but stopping the selection halfway. The example shown in FIG. 15E corresponds to this.

If it is determined in step S501 that there is no selected object at the position that is to be undesignated, the instruction state management unit 103 or the like cancels the scrolled state in step S508.

This corresponds to releasing a finger that has been used for depressing and dragging for scrolling. The example shown in FIG. 16B corresponds to this.

Note that in the above description in this embodiment, the action of depressing and dragging a point at which there is no object in a state in which not a single point is designated has been treated as a scroll instruction.

Here, it is possible to provide means for selecting a plurality of objects by dragging the plurality of objects so as to circle them.

An example for this case will now be described. In this case, simply dragging the background is not treated as a scroll instruction, and dragging performed in the presence of a locked object is only treated as a scroll instruction.

FIGS. 16E and 16F show an example in which the periphery of objects is traced so as to circle the objects, and the objects located therein are selected. In FIG. 16E, a region outside a plurality of objects is designated with the right hand 3101, and the periphery thereof is traced. After completing such tracing, the region is undesignated.

Then, as shown in FIG. 16F, objects 3102 located within the traced region are put into the selected state. These objects that have been put into the selected state are depressed and thereby locked.

Furthermore, dragging a region in which there is no object enables scrolling while keeping the plurality of objects locked.

The overall flow of the display control processing in this embodiment is the same as the flowchart in FIG. 2. In the following, the start of designation, movement, and undesignation in this embodiment are described.

Note that processing that is the same as the above-described processing is denoted with the same reference numerals, with the descriptions thereof omitted, and processing that is different from the above-described processing will be described.

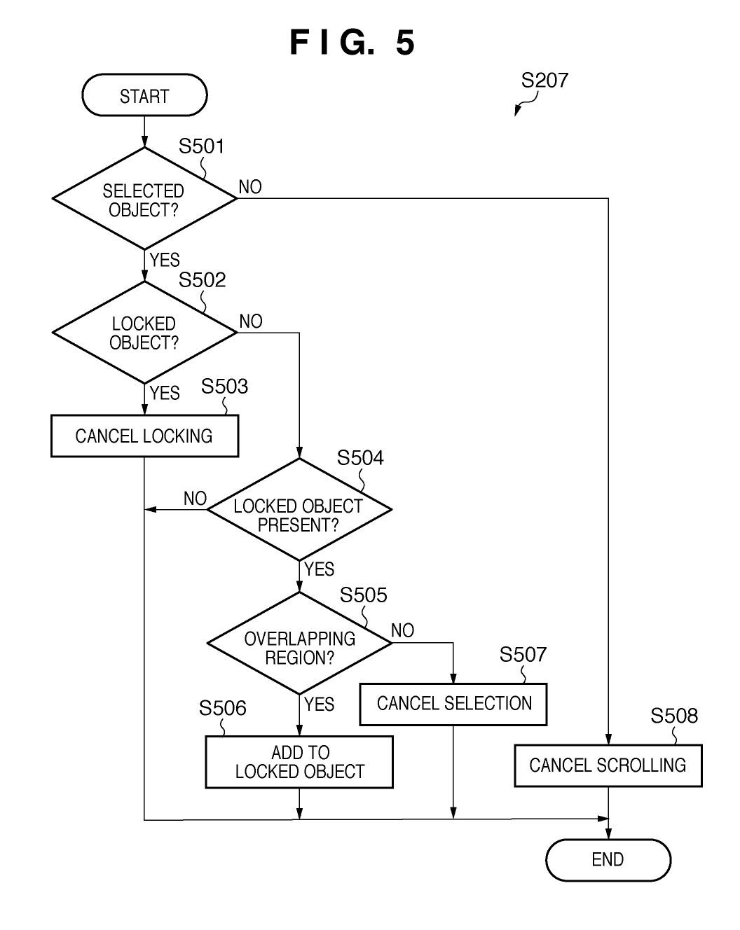

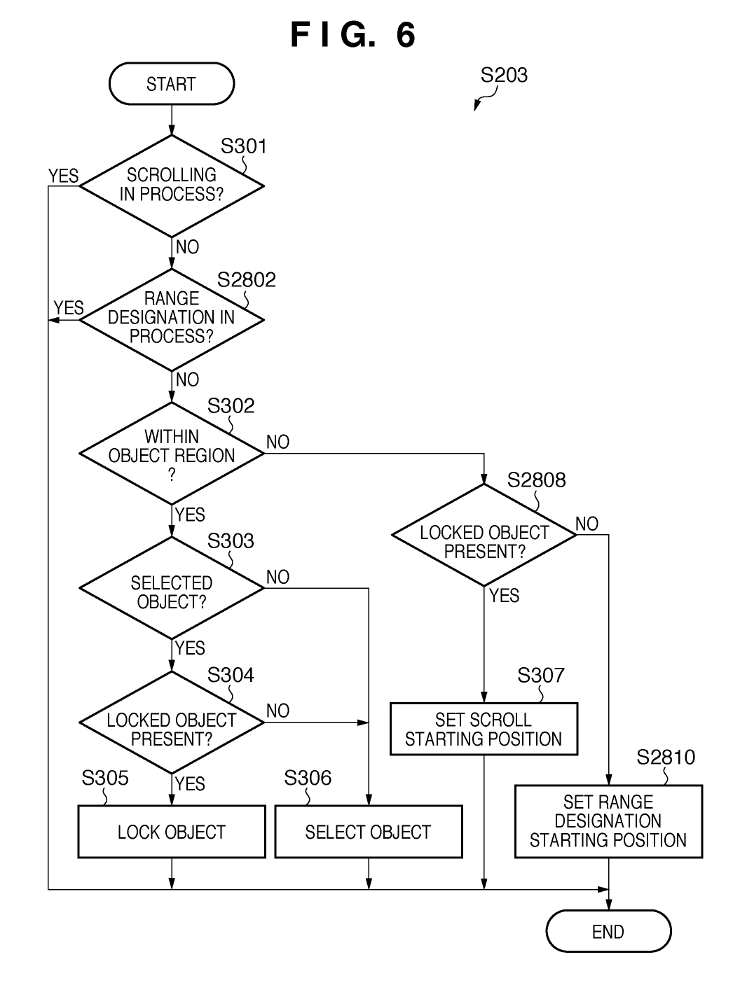

FIG. 6 is a flowchart illustrating a modification of the designation start processing in step S203.

FIG. 6 is different from FIG. 3 in that it includes processing of steps S2802, S2808, and S2810.

In step S2802, which is inserted between step S301 and step S302, if it is determined in step S301 that scrolling is not in process, the instruction state management unit 103 or the like determines whether range designation is in process.

If it is determined in step S2802 that range designation is in process, the processing series ends directly. Again, the reason is to prevent another object from being selected, for example, by being touched by mistake during range designation.

Step S2808 is inserted between S302 and S307. If it is determined in step S302 that the designated point is outside an object region, the object management unit 107 or the like determines, in step S2808, whether there is any locked object.

If a locked object is present, this is treated as a scroll instruction, and a scroll starting position is set in step S307, and the processing ends.

On the other hand, if there is no locked object in step S2808, the instruction state management unit 103 or the like treats, in step S2810, this as a select operation using circling, and sets a range designation starting position, and the processing ends.

Depressing a background area with the right hand 3101 in FIG. 16E corresponds to this.

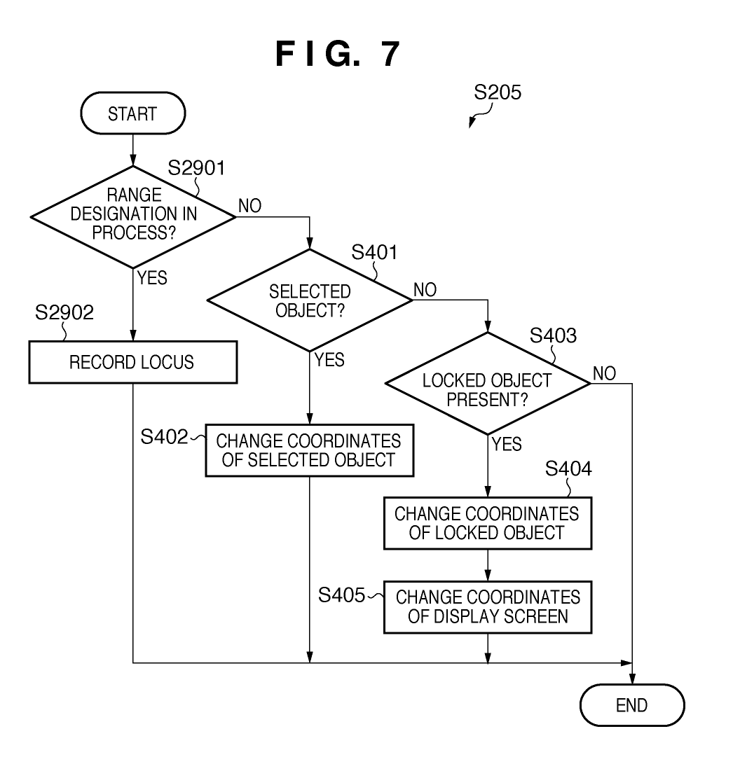

FIG. 7 is a flowchart illustrating a modification of the movement processing in step S205.

FIG. 7 is different from FIG. 4 in that, prior to the processing of step S401, the instruction state management unit 103 or the like first determines, in step S2901, whether range designation is in process.

Next, if range designation is in process, the instruction state management unit 103 or the like then records, in step S2902, the movement as a locus of the range designation, and the processing ends. If range designation is not in process, the above-described processing at and after step S401 is executed.

However, if it is determined in step S403 that there is no locked object, the processing series ends directly. Note that tracing the periphery of the objects with the right hand 3101 in FIG. 16E corresponds to this.

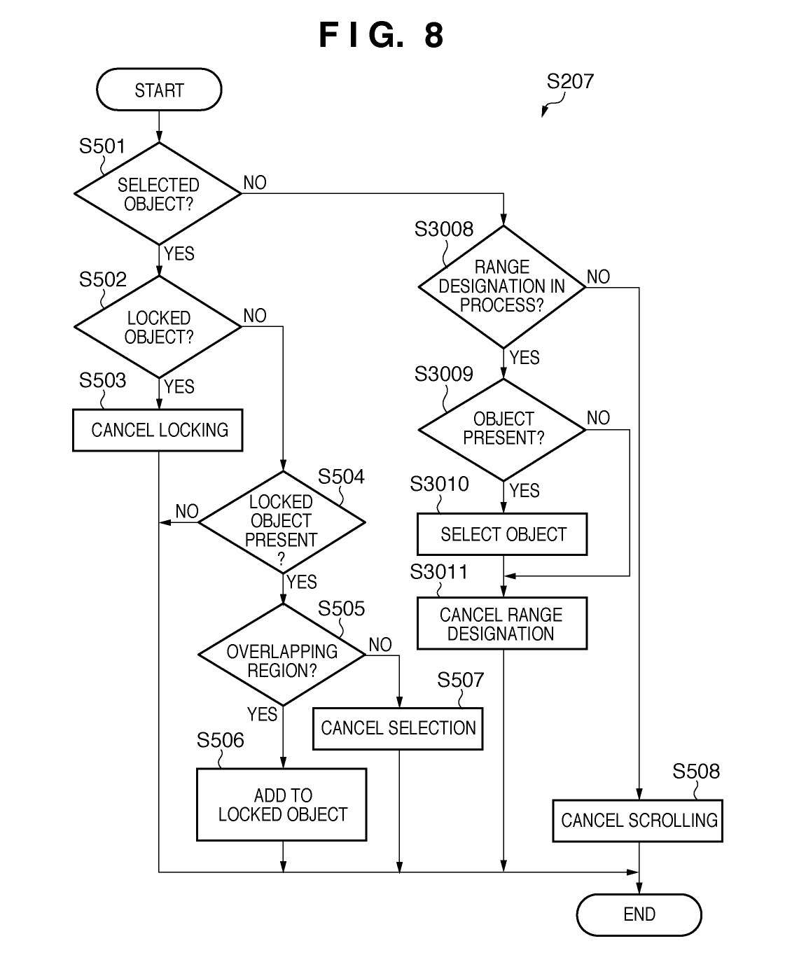

FIG. 8 is a flowchart illustrating a modification of the undesignation processing in step S207.

FIG. 8 is different from FIG. 5 in that step S3008 at which the instruction state management unit 103 or the like determines whether range designation is in process is inserted between step S501 at which it is determined whether there is any selected object at the position that is to be undesignated and step S508 at which the scrolled state is cancelled.

If range designation is in process here, the object management unit 107 or the like determines, in step S3009, whether there is any object in the designated range.

If an object is present, the object management unit 107 or the like, in step S3010, puts that object into the selected state, and executes the processing of step S3011. On the other hand, if there is no object, it directly proceeds to execute the processing of step S3011.

In step S3011, the instruction state management unit 103 cancels the range designation, and the processing series ends. Note that this corresponds to tracing the periphery of objects so as to circle them, thereby selecting the objects located therein.

FIG. 16F shows an example in the case where the objects indicated by 3102 have been put into the selected state.

In the above description, a group of objects that can be locked is limited to one, since it is difficult to keep track of a plurality of locked objects.

However, a plurality of groups of objects that can be locked may be provided. That is, a plurality of groups each containing a plurality of objects can be simultaneously selected with a plurality of points as fixing targets.

In this case, the processing step of step S304 of FIG. 3 and FIG. 6 is omitted, and the designation of a point on the selected object is unconditionally treated as locking the object.

Further, prior to step S503 of FIG. 5 and FIG. 8, the overlap with another locked object is checked, and the locked state and the selected state will not be cancelled if there is an overlap. In this case, separate locked objects can be designated with a plurality of fingers.

Although a plurality of points that can be locked can be provided in the above description, it will be physically difficult to lock three or more points by depressing them and to scroll other points in that state. For example, it is difficult to depress three or more scattered objects with one hand.

Therefore, the user may specify a condition for an object that is to be locked, rather than locking objects by selecting them all with fingers. While methods of inputting such a condition include a character input and selection by menu, an example is given here in which the condition is designated by means of voice recognition.

An example of the operation performed in this case is shown in FIGS. 16G and 16H. By performing voice recognition designating a condition in a state in which locking with a finger is being performed, those objects satisfying the condition, among the objects appearing within the image display unit, are put into the locked state.

In FIG. 16G, the condition “Year 2007” is input by voice in a state in which a locked object 3202 is depressed with the left hand 3201 and a point at which there is no object is depressed with the right hand 3203.

FIG. 16H shows a state in which, among the objects located on the display screen, an object 3204 that satisfies the condition “Year 2007” is locked.

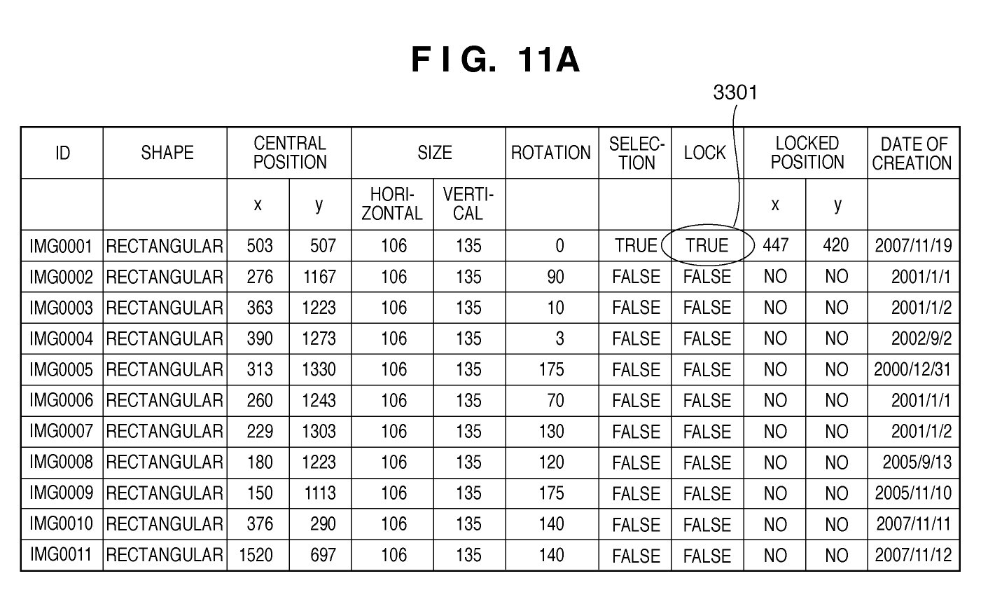

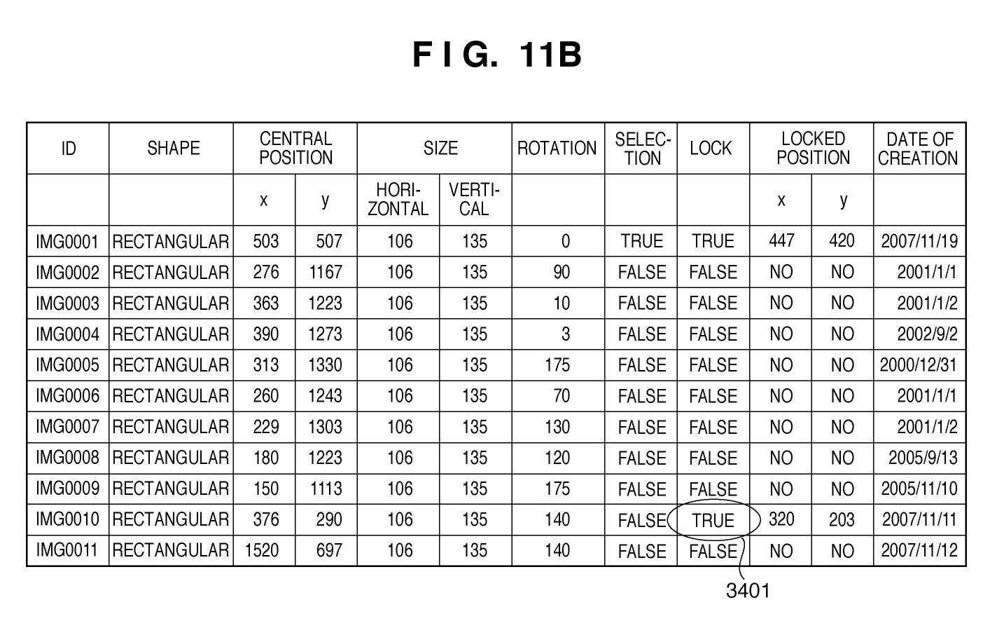

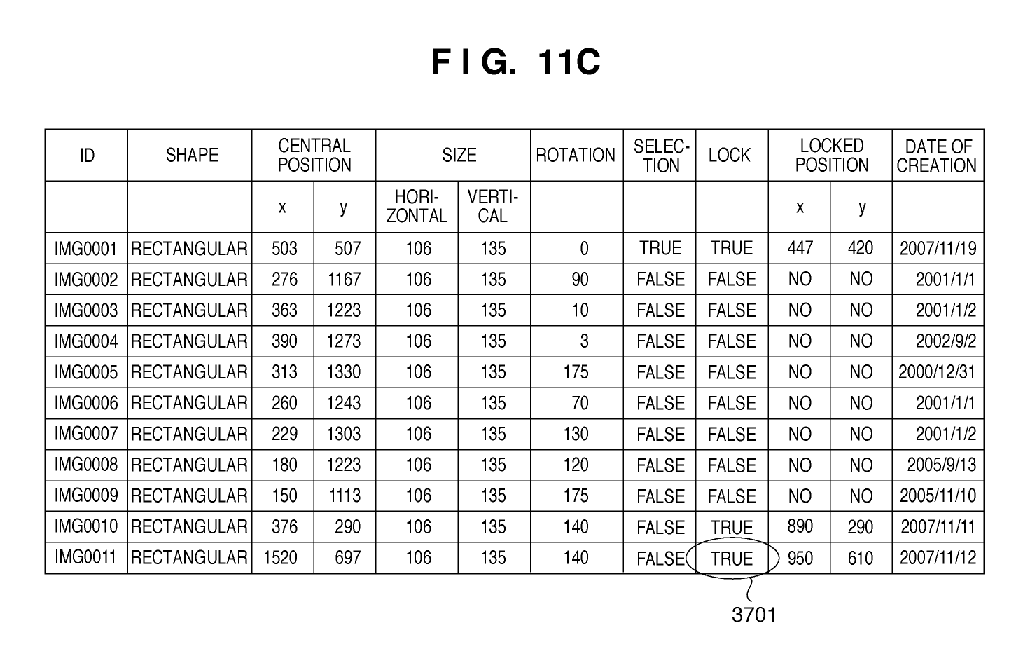

FIG. 11A is a diagram showing the details of the content management table before the condition is applied in the scene of FIG. 16G. Here, the data field “date of creation” is assumed to be added to the content management table.

Here, depressing with the left hand 3201 has put only IMG0001 into the locked state (TRUE) as indicated by 3301.

FIG. 11B is a diagram showing the details of the content management table after the condition “Year 2007” has been designated. IMG0010, whose central position is located on the display screen and whose date of creation is Year 2007, has been put into the locked state (TRUE) as indicated by 3401.

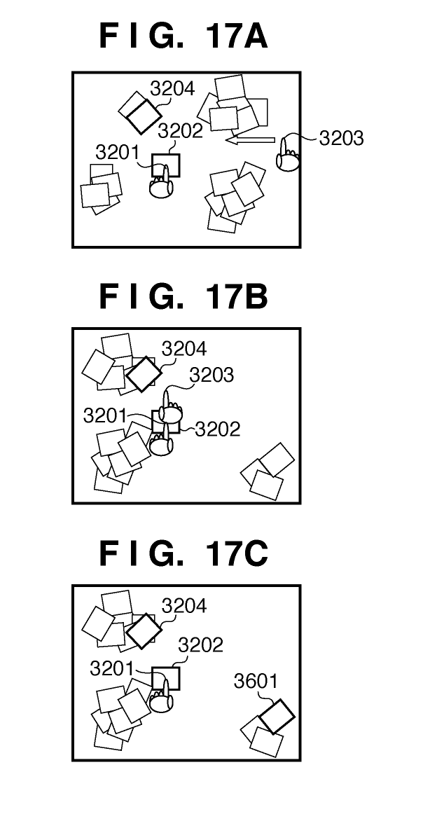

An example of the scroll operation is shown in FIGS. 17A to 17C. In FIG. 17A, by sliding across the display screen to the left with the right hand 3203, the display screen is scrolled while keeping the positions on the display screen of the object 3202 depressed with the left hand 3201 and the object 3204 that has been locked by voice.

FIG. 17B shows a state in which a scroll operation has been stopped.

FIG. 17C is a diagram showing an example in which a lock operation is performed on an object that has newly appeared in the image display unit.

Upon releasing the right hand 3203 that has been performing scrolling, the condition “Year 2007” is also applied to objects that have newly appeared in the image display unit, and the relevant object 3601 is locked.

As shown in FIG. 11C, IMG0011 in the content management table is in the locked state (TRUE) as indicated by 3701. The lock condition is cancelled in accordance with the command “condition cancellation” by voice recognition.

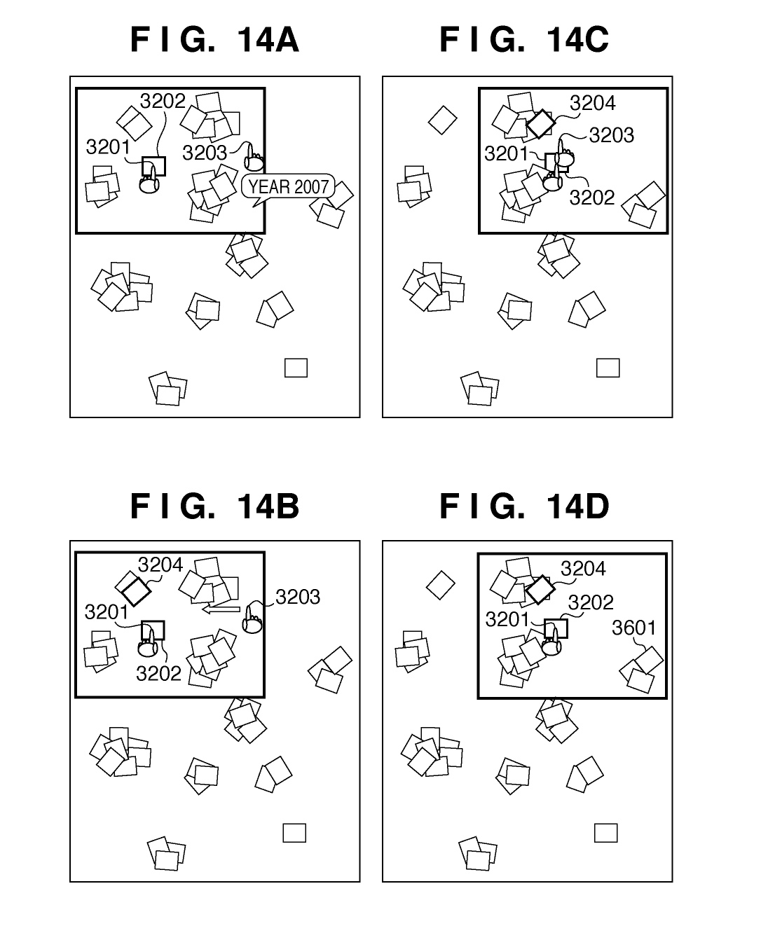

These operations for the content as viewed in its entirety are as shown in FIGS. 14A to 14D. FIG. 16G corresponds to FIG. 14A, FIG. 17A corresponds to FIG. 14B, FIG. 17B corresponds to FIG. 14C, and FIG. 17C corresponds to FIG. 14D.

Although the condition for locking is designated by voice, conversely, a condition for not locking may be designated by voice.

In the above-description, when an object that the user wishes to remove from the locked objects is present in the above description, the locking is temporarily cancelled. Thereafter, the user has to move away the object that is to be removed by dragging it, select the other objects again by tracing the periphery thereof so as to encircle them, and depress the objects.

Instead, it is also possible to designate one object included in a group of locked objects at another point, drag the object, and then release it, thereby removing the object from the locked objects.

In the above description, when the undesignation of locked objects is detected during scrolling, the locking is cancelled and scrolling is performed in that state. However, scrolling may be suspended when there is undesignation of the locked objects during scrolling.

In the above description, the three types of coordinate designation inputs are set, namely, start of designation, movement, and undesignation. However, not only movement, but also continuation may be a target for processing as well.

In that case, if an input has been detected at a position at which no input was detected at the same position at the immediately preceding detection time (hereinafter, referred to as “the immediately preceding instance”), and no input was made on the immediately preceding instance at a position neighboring that position, this is determined as the “start of designation”.

If an input at the same position as the immediately preceding instance is detected, this is determined as “continuation”. In the case where an input has been detected at a position at which no input was detected at the immediately preceding instance, if an input was detected at a position neighboring that position at the immediately preceding instance, but no input has been detected at this neighboring position at the present instance (the current detection time), this is determined as “movement”.

If an input has been detected at a position at the immediately preceding instance, but no input has been detected at that position at the present occasion, this is determined as “undesignation”. Further, the continuation processing may be such that, when a region in which a plurality of objects overlap is depressed for a certain period of time, all of the plurality of objects may be put into the selected state.

In the above description, the display screen can only be moved within the content area, and an end portion of the content area can only be displayed at an end of the display screen.

To address this problem, the user needs to move the display screen to an end in the case of a large screen. In contrast, it is possible to provide a margin at the edge of the content area, and to allow an end portion of the content to be displayed on the central portion of the display screen.

Although the objects are displayed as rectangles in the above description, the present invention is not limited to this. In the case of an object having a complex contour, it is also possible to use vector representation, for example.

Although the display screen has only one type of coordinates for the display screen in the above description, it is also possible for the display screen to have a relative position on the physical display screen so as to be adapted to multi-window applications.

In the above description, an object in the selected state is put into the locked state at the time when a coordinate designation is made for that object. Instead, it is also possible to put the object into the locked state at the time when a scroll instruction is made or another object is dragged.

In the above description, there is no mention of a method for cancelling the selected state of an object when there is no locked state.

In this regard, not performing undesignation for a certain period of time after designation may be set as a condition for putting the object in the selected state into the locked state, and the selected state may be cancelled when the time between the coordinate designation and the coordinate undesignation of the object in the selected state is short.

Alternatively, the selected state may be cancelled when the time between the coordinate designation and the coordinate undesignation of the background in which there is no object is short.

### Embodiment 2

Next, a case is described where the switching of processing is performed for the scroll operation and the like using the so-called multi-touch described in Embodiment 1, according to, the number, the position, the presence or absence of a movement, and the like of points that are designated.

Although this embodiment describes processing performed in a case where there is a single designated position and a case where there are two designated positions, the processing performed in the case where there are two designated positions may be applied to a case where there are three or more designated positions.

An information processing apparatus according to this embodiment is the same as that of Embodiment 1, and therefore, the description thereof has been omitted.

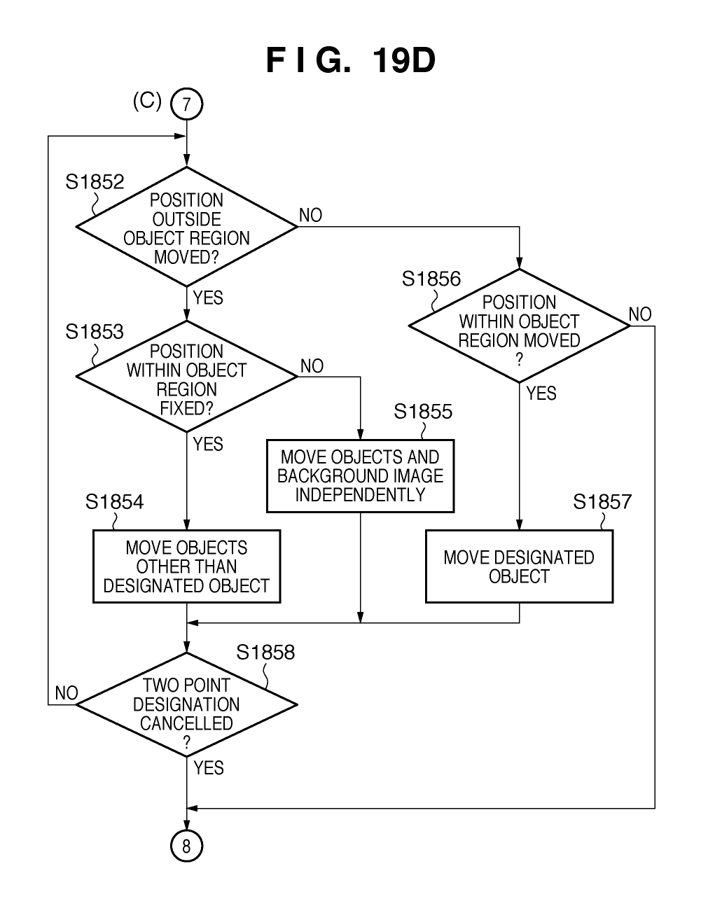

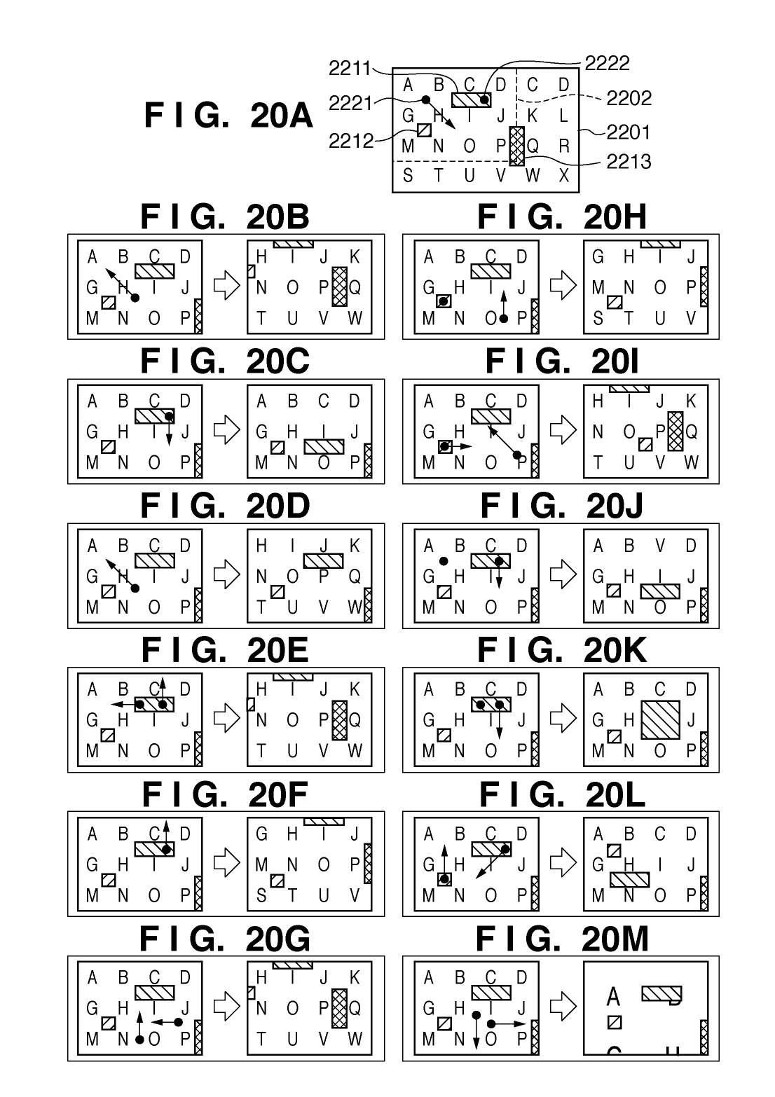

FIGS. 20A to 20M are diagrams showing an example of the operation performed on objects and the background image. FIG. 20A is a diagram for illustrating various elements.

A background image 2201 corresponds to the entire object placement screen (content) 601, and is an image in which the characters A to X are drawn.

Note that the characters A to X in the background image 2201 are intended to clearly illustrate processing such as scrolling, and the background image 2201 may also be a blank image, for example.

A display screen 2202 is the same as the display screen 602, and therefore, the description thereof has been omitted.

Objects 2211, 2212 and 2213 are images or the like that are superimposed on the background image 2201, and these objects are images or the like that can be moved independently of the movement of the background image 2201.

2221 indicates an operation performed by the user, wherein a circle indicates the starting point of a designating operation performed by the user, the locus indicated by a line indicate a movement of a point that is designated by the user, and the direction indicated by an arrow indicates the direction of movement. That is, 2221 indicates the movement of the point that is designated.

While 2222 also indicates an operation performed by the user, it is composed only of a circle indicating the starting point of a designating operation performed by the user. That is, 2222 indicates that the point that is designated is fixed.

In other words, it can be considered that, in FIG. 20A, a single designating operation is performed by the user on each of the object 2211 and the background image 2201 in a state in which the entirety of the objects 2211 and 2212 and a portion of the object 2213 are displayed on the display screen.

Additionally, it is shown that the point designating an area on the object 2211 does not move, and the point designating the background image 2201 moves to the lower right.

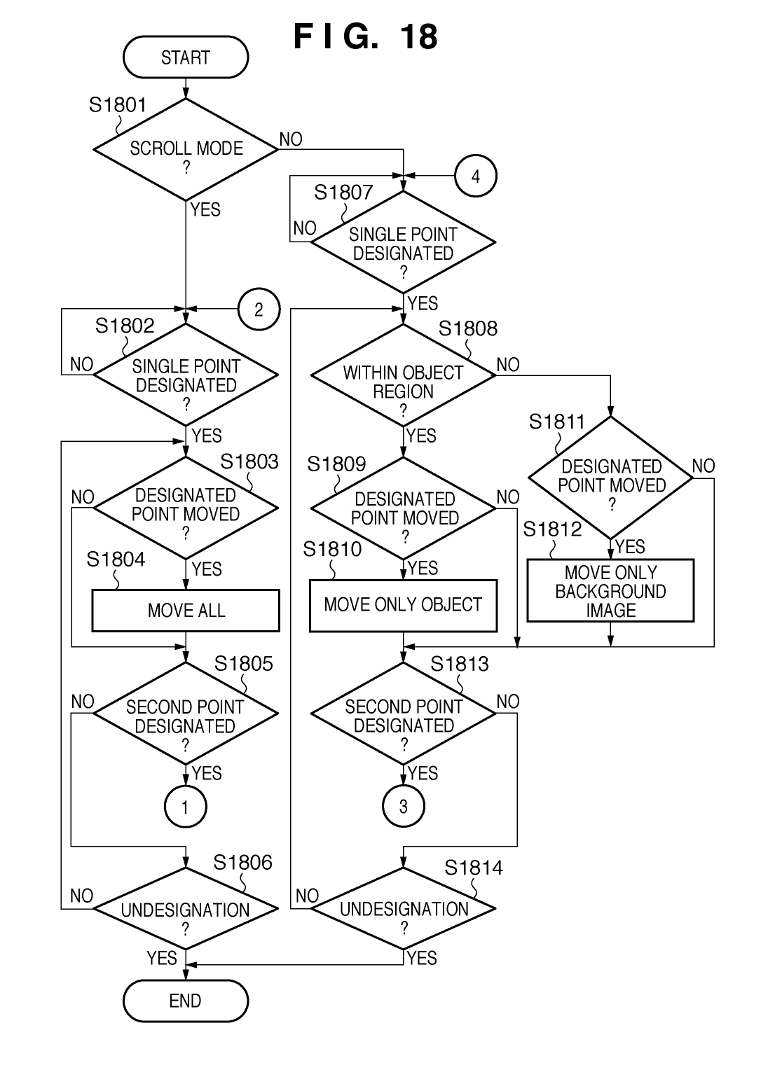

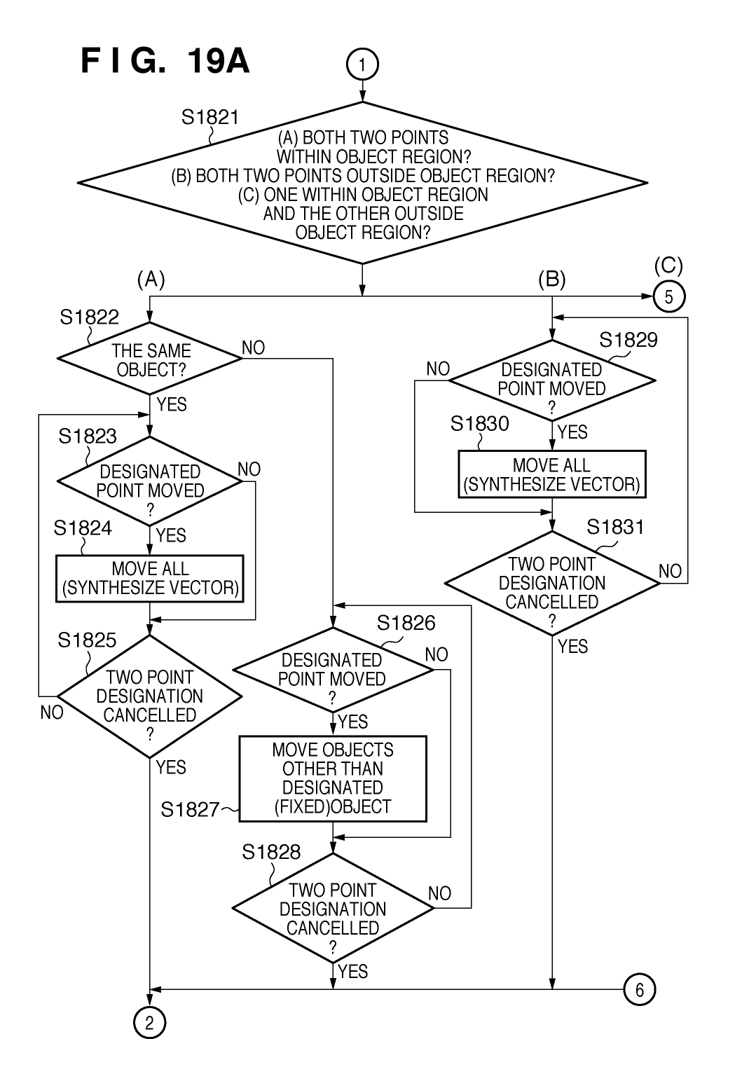

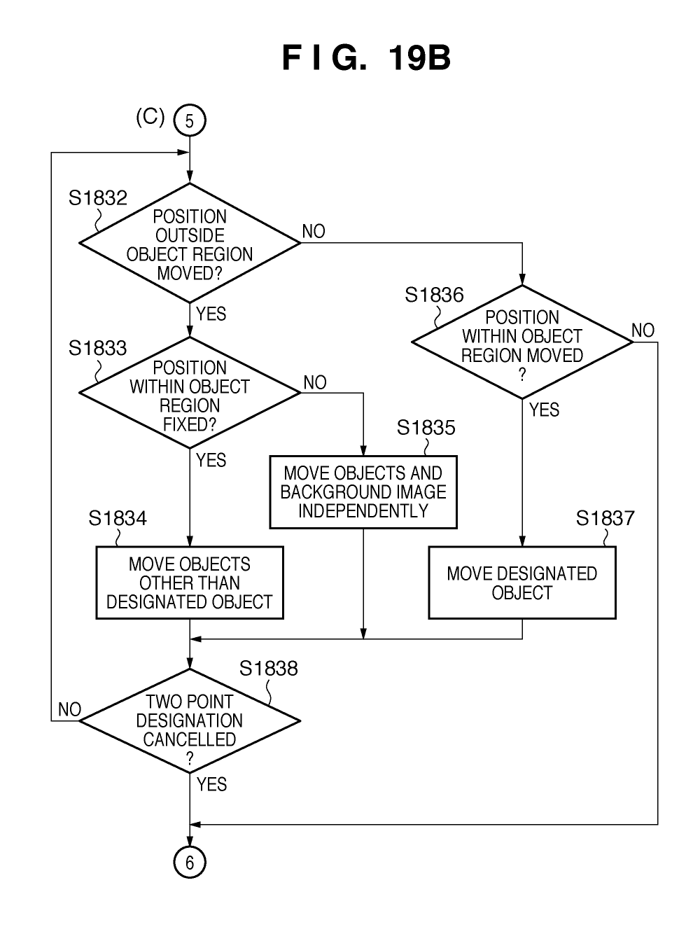

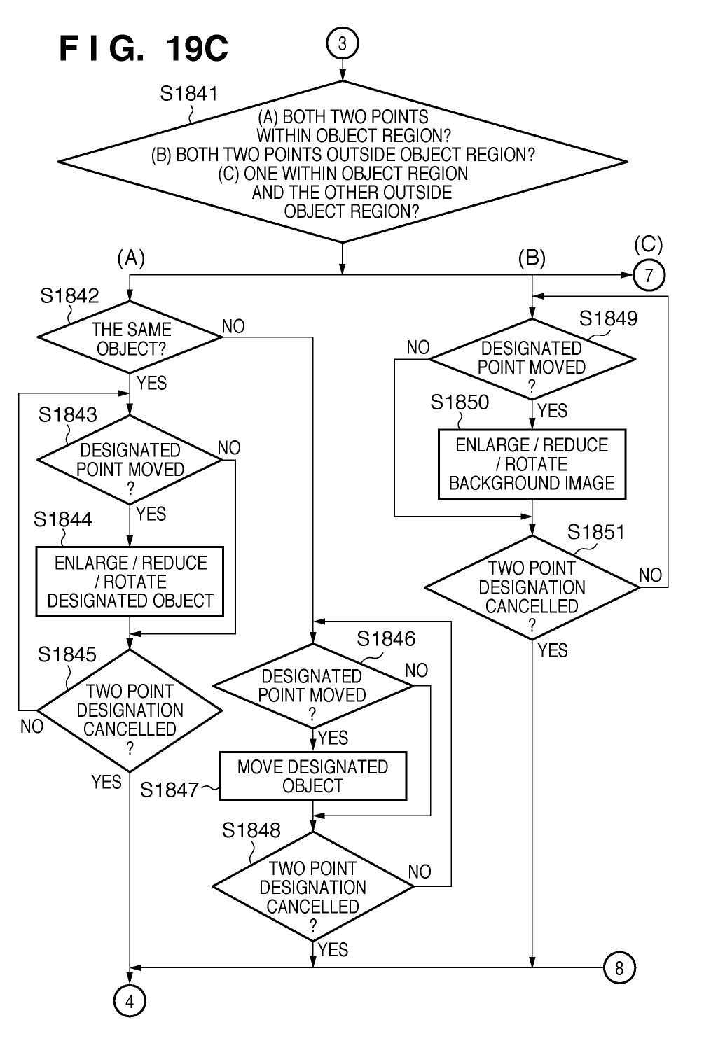

Further, FIGS. 18, and FIGS. 19A to 19D are flowcharts illustrating processing performed in a case where processing is switched according to the number, the position, and the presence or absence of a movement, and the like of points that are designated. The following description is given in line with the flowcharts.

Note that an information processing apparatus according to this embodiment includes a mode for scrolling, and modes that are not for scrolling, including for example, modes for enlarging, reducing, or rotating an object, the background screen, and the like.

Note that a user's action for designating of a point triggers a start of the processing shown in FIG. 18, and a user's action for canceling a designation of a point triggers an end of the processing. When two or more actions such as a user's action for designating of a point and a user's action for canceling a designation of a point are occurred at the same time, a processing corresponding to one user's action is initially executed, and then a processing corresponding to another user's action is executed.

In step S1801, the CPU 1 or the like determines whether the current mode is a scroll mode, and executes the processing in step S1802 if it is determined that the current mode is a scroll mode.

On the other hand, if it is determined that the mode is not a scroll mode, the CPU 1 or the like executes the processing of step S1807.

In step S1802, the instruction determination unit 102 determines whether a point that is designated has been input into the coordinate input unit 101, and executes the processing of step S1803 if it has been input. On the other hand, if it has not been input, the processing of step S1802 is repeated.

In step S1803, the instruction determination unit 102 determines whether the point that is designated has moved, and executes the processing of step S1804 if it has moved. On the other hand, if it has not moved, the instruction determination unit 102 executes the processing of step S1805.

In step S1804, the display control unit 105 scrolls the objects and the background image according to the amount of movement of the movement locus of the point that is designated, without changing the relative position between the objects and the background image. Note that an example of the processing of step S1804 is as shown in FIG. 20B.

In step S1805, the instruction determination unit 102 determines whether another point that is a designated point has been input into the coordinate input unit 101 in a state where a prior input is continued, and executes the processing of step S1821 if it has been input.

On the other hand, if a different point has not been input, it executes the processing of step S1806.

In step S1806, the instruction determination unit 102 determines whether a prior input that has been made to the coordinate input unit 101 has been cancelled, and ends the processing series if it has been cancelled. On the other hand, if it has not been cancelled, the instruction determination unit 102 executes the above-described processing of step S1803.

In step S1807, the instruction determination unit 102 determines whether a point that is designated has been input into the coordinate input unit 101, and executes the processing of step S1808 if it has been input. On the other hand, if it has not been input, the instruction determination unit 102 repeats the processing of step S1807.

In step S1808, the coordinate management unit 104 or the like determines whether the point that is designated is in a region in which an object is displayed, and executes the processing of step S1809 if it is in a region in which an object is displayed.

On the other hand, if it is not in a region in which an object is displayed, the coordinate management unit 104 or the like executes the processing of step S1811.

In step S1809, the instruction determination unit 102 determines whether the point that is designated has moved, and executes the processing of step S1810 if it has moved. On the other hand, if it has not moved, the instruction determination unit 102 executes the processing of step S1813.

In step S1810, the display control unit 105 moves only the designated object according to the amount of movement of the movement locus of the point that is designated. Note that an example of the processing of step S1810 is as shown in FIG. 20C.

In step S1811, the instruction determination unit 102 determines whether the point that is designated has moved, and executes the processing of step S1812 if it has moved. On the other hand, if it has not moved, the instruction determination unit 102 executes the processing of step S1813.

In step S1812, the display control unit 105 only moves the background image according to the amount of movement of the movement locus of the point that is designated. Note that an example of the processing of step S1812 is as shown in FIG. 20D.

In step S1813, the instruction determination unit 102 determines whether another point that is designated has been input to the coordinate input unit 101 in a state where a prior input is continued, and executes the processing of step S1841 if it has been input.

On the other hand, if no other point has been input, it executes the processing of step S1814.

In step S1814, the instruction determination unit 102 determines whether a prior input that has been made to the coordinate input unit 101 has been cancelled, and ends the processing series if it has been cancelled. On the other hand, if it has not been cancelled, the instruction determination unit 102 executes the above-described processing of step S1808.

In step S1821, the coordinate management unit 104 or the like determines whether the two designated points are both within an object region, both outside an object region, or one of them is within an object region and the other is outside an object region.

If it is determined that both are within an object region, the coordinate management unit 104 or the like executes the processing of step S1822, or executes the processing of step S1829 if it is determined that both are outside an object region.

If it is determined that one is within an object region and the other is outside an object region, the coordinate management unit 104 or the like executes the processing of step S1832.

In step S1822, the coordinate management unit 104 or the like determines whether the two points are located in a region in which the same object is displayed, and executes the processing of step S1823 if the two points are located in a region in which the same object is displayed.

On the other hand, if the two points are not located in a region in which the same object is displayed, the coordinate management unit 104 or the like executes the processing of step S1826.

In step S1823, the instruction determination unit 102 determines whether at least one of the two points has moved, and executes the processing of step S1824 if it has moved. On the other hand, if it has not moved, the instruction determination unit 102 executes the processing of step S1825.

In step S1824, the display control unit 105 scrolls the objects and the background image according to the amount of movement of the movement locus of the point that is designated, without changing the relative position between the objects and the background image. Note that an example of the processing of step S1824 is as shown in FIG. 20E.

In step S1825, the instruction determination unit 102 determines whether at least one of the prior inputs that have been made to the coordinate input unit 101 has been cancelled, and executes the processing of step S1802 if it has been cancelled.

On the other hand, if it has not been cancelled, the instruction determination unit 102 executes the above-described processing of step S1823.

In step S1826, the instruction determination unit 102 determines whether one of the two points has moved, and executes the processing of step S1827 if it has moved. On the other hand, if it has not moved, the instruction determination unit 102 executes the processing of step S1828.

In step S1827, display control unit 105, without changing the display position of the object designated by the fixed point, scrolls the other objects and the background image according to the amount of movement of the movement locus of the point that is designated.

Note that an example of the processing of step S1827 is as shown in FIG. 20F. Further, a case where two points move together is also conceivable, and a point with a smaller amount of movement may be regarded as a fixed point in this case.

In step S1828, the instruction determination unit 102 determines whether at least one of the prior inputs that have been made into the coordinate input unit 101 has been cancelled, and executes the processing of step S1802 if it has been cancelled.

On the other hand, if it has not been cancelled, the instruction determination unit 102 executes the above-described processing of step S1826.

In step S1829, the instruction determination unit 102 determines whether at least one of the two points has moved, and executes the processing of step S1830 if it has moved. On the other hand, if it has not moved, the instruction determination unit 102 executes the processing of step S1831.

In step S1830, the display control unit 105 scrolls the objects and the background image according to the amount of movement of the movement locus of the point that is designated, without changing the relative position between the objects and the background image. Note that an example of the processing of step S1830 is as shown in FIG. 20G.

In step S1831, the instruction determination unit 102 determines whether at least one of the prior inputs that have been made into the coordinate input unit 101 has been cancelled, and executes the processing of step S1802 if it has been cancelled.

On the other hand, if it has not been cancelled, the instruction determination unit 102 executes the above-described processing of step S1829.

In step S1832, the instruction determination unit 102 or the like determines whether the point designating a position outside the region in which an object is displayed has moved, and executes the processing of step S1833 if it has moved.

On the other hand, if the point designating a position outside the region in which an object is displayed has not moved, the instruction determination unit 102 or the like executes the processing of step S1836.

In step S1833, the instruction determination unit 102 or the like determines whether a point designating a position within the region in which an object is displayed is fixed, and executes the processing of step S1834 if it is fixed.

On the other hand, if the point designating a position within the region in which an object is displayed is not fixed, the instruction determination unit 102 or the like executes the processing of step S1835.

In step S1834, the display control unit 105, without changing the display position of the object designated by the fixed point, scrolls the other objects and the background image according to the amount of movement of the movement locus of the point that is designated.

Note that an example of the processing of step S1834 is as shown in FIG. 20H.

In step S1835, the display control unit 105 moves the designated object and scrolls objects other than the designated object and the background image, according to the amount of movement of the movement locus of the point that is designated.

Note that the amount of movement and the direction of movement of the designated object are independent from the amount of movement and the direction of movement for scrolling objects other than the designated object and the background image, and an example of the processing of step S1835 is as shown in FIG. 20I.

In step S1836, the instruction determination unit 102 or the like determines whether the point designating a position within the region in which an object is displayed has moved, and executes the processing of step S1837 if it has moved.

In step S1837, the display control unit 105 only moves the designated object according to the amount of movement of the movement locus of the point that is designated. Note that an example of the processing of step S1837 is as shown in FIG. 20J.

Upon execution of the processing of steps S1834, S1835, and S1837, the instruction determination unit 102 determines, in step S1838, whether at least one of the prior inputs that have been made into the coordinate input unit 101 has been cancelled.

Then, if at least one of the prior inputs has been cancelled, the instruction determination unit 102 executes the processing of step S1802, and executes the above-described processing of step S1832 if it has not been cancelled.

In step S1841, the coordinate management unit 104 or the like determines whether the two designated points are both within an object region, or both outside an object region, or one of them is within an object region and the other is outside an object region.

If it is determined that both are within an object region, the coordinate management unit 104 or the like executes the processing of step S1842, and executes the processing of step S1849 if it is determined that both are outside an object region.

If it is determined that one is within an object region and the other is outside an object region, the coordinate management unit 104 or the like executes the processing of step S1852.

In step S1842, the coordinate management unit 104 or the like determines whether the two points are located in a region in which the same object is displayed, and executes the processing of step S1843 if the two points are located in a region in which the same object is displayed.

On the other hand, if the two points are not located in a region in which the same object is displayed, the coordinate management unit 104 or the like executes the processing of step S1846.

In step S1843, the instruction determination unit 102 determines whether at least one of the two points has moved, and executes the processing of step S1844 if it has moved. On the other hand, if it has not moved, the instruction determination unit 102 executes the processing of step S1845.

In step S1844, the display control unit 105 performs enlargement, reduction, rotation, etc., of the designated object according to the amount of movement of the movement locus of the point that is designated. This processing is performed using a well-known technique. Note that an example of the processing of step S1844 is as shown in FIG. 20K.

In step S1845, the instruction determination unit 102 determines whether at least one of the prior inputs that have been made to the coordinate input unit 101 has been cancelled, and executes the processing of step S1807 if it has been cancelled.

On the other hand, if it has not been cancelled, the instruction determination unit 102 executes the above-described processing of step S1843.

In step S1846, the instruction determination unit 102 determines whether one of the two points has moved, and executes the processing of step S1847 if it has moved. On the other hand, if it has not moved, the instruction determination unit 102 executes the processing of step S1848.

In step S1847, display control unit 105 moves the display position of the designated object according to the amount of movement of the movement locus of the point that is designated. Note that an example of the processing of step S1847 is as shown in FIG. 20L.

In step S1848, the instruction determination unit 102 determines whether at least one of the prior inputs that have been made to the coordinate input unit 101 has been cancelled, and executes the processing of step S1807 if it has been cancelled.

On the other hand, if it has not been cancelled, the instruction determination unit 102 executes the above-described processing of step S1846.

In step S1849, the instruction determination unit 102 determines whether at least one of the two points has moved, and executes the processing of step S1850 if it has moved. On the other hand, if it has not moved, the instruction determination unit 102 executes the processing of step S1851.

In step S1850, the display control unit 105 performs enlargement, reduction, rotation, etc. of the background image according to the amount of movement of the movement locus of the point that is designated, without changing the display position of the object. Note that the processing of step S1850 is as shown in FIG. 20M.

In step S1851, the instruction determination unit 102 determines whether at least one of the prior inputs that have been made into the coordinate input unit 101 has been cancelled, and executes the processing of step S1807 if it has been cancelled.

On the other hand, if it has not been cancelled, the instruction determination unit 102 executes the above-described processing of step S1849.

The processing from step S1852 to step S1858 is the same as the processing from step S1832 to step S1838, and therefore, the description thereof has been omitted.

Note that in steps S1824 and S1830, the amount of movement of a movement locus that is designated may be the sum of the amounts of movement of the movement loci of the two points, or may be the average of the amounts of movement of the movement loci of the two points.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-226376, filed Sep. 3, 2008, and No. 2009-174517, filed Jul. 27, 2009, which are hereby incorporated by reference herein in their entirety.

What is claimed is:

1. An information processing apparatus that controls a display position of an object displayed in a display unit, the apparatus comprising:
a display unit configured to display an object;
a recognition unit configured to recognize that a plurality of positions on the display unit have been designated; and
a display control unit configured, where a first position corresponding to a position at which one of a plurality of objects is displayed is recognized by the recognition unit and a second position corresponding to a position that is located on the display unit and at which a designated object is not displayed is recognized by the recognition unit, to scroll objects other than the designated object, when a movement of the second position has been detected.

2. The information processing apparatus according to claim 1,
wherein the display control unit is further configured not to move the position at which the designated object is displayed when a movement of the first position has not been detected, and
the display control unit is further configured to move the position at which the designated object is displayed when a movement of the first position has been detected, based on an amount of movement and a direction of movement corresponding to a movement locus of the first position, regardless of an amount of movement and a direction of movement of the scroll.

3. An information processing apparatus that controls a display position of an object displayed in a display unit, the apparatus comprising:
a display unit configured to display an object;
a recognition unit configured to recognize that a plurality of positions on the display unit have been designated; and
a display control unit configured, where a first position corresponding to a position at which one of a plurality of objects is displayed is recognized by the recognition unit and the second position corresponding to a position that is located on the display unit and at which a designated object is not displayed is recognized by the recognition unit, to scroll objects other than the designated object based on an amount of movement and a direction of movement corresponding to a movement locus of the second position, without changing a position at which the designated object is displayed, when a movement of the second position has been detected without a movement of the first position;
the display control unit being configured to move the position at which the designated object is displayed based on an amount of movement and a direction of movement corresponding to a movement locus of the first position, and to scroll objects other than the designated object based on an amount of movement and a direction of movement corresponding to a movement locus of the second position, when a movement of the first position has been detected and a movement of the second position has been detected; and,
the display control unit being configured to move the position at which the designated object is displayed based on an amount of movement and a direction of movement according to a movement locus of the first position, without changing positions at which a plurality of objects other than the designated object are displayed on the display unit, when a movement of the first position has been detected without a movement of the second position.

4. The information processing apparatus according to claim 1,
wherein the objects are images superimposed on a background image.

5. The information processing apparatus according to claim 1,
wherein the recognition unit recognizes that said positions have been designated, in response to a user operation performed on an input unit superimposed on the display unit.

6. A method for operating an information processing apparatus that controls a display position of an object displayed in a display unit, the method comprising:
a display step of displaying an object;
a recognition step of recognizing that a plurality of positions on the display unit have been designated; and
a display control step of, where a first position corresponding to a position at which one of a plurality of objects is displayed is recognized by the recognition step and a second position corresponding to a position that is located on the display unit and at which a designated object is not displayed is recognized by the recognition step, scrolling objects other than the designated object, when a movement of the second position has been detected.
